(19) United States
(12) Patent Application Publication
(10) Pub. No.: US 2023/0150524 A1
(43) Pub. Date: May 18, 2023

(54) REPLACEMENT CONFIRMATION SYSTEM AND REPLACEMENT CONFIRMATION METHOD

(71) Applicant: TOYOTA JIDOSHA KABUSHIKI KAISHA, Toyota-shi (JP)

(72) Inventors: Daiki YOKOYAMA, Shizuoka-ken Gotemba-shi (JP); Tomohiro KANEKO, Shizuoka-ken Mishima-shi (JP)

(73) Assignee: TOYOTA JIDOSHA KABUSHIKI KAISHA, Toyota-shi (JP)

(21) Appl. No.: 17/984,633

(22) Filed: Nov. 10, 2022

(30) Foreign Application Priority Data
Nov. 17, 2021 (JP) 2021-186914

(51) Int. Cl. B60W 50/08; G05B 13/02; B60W 50/14

(52) U.S. Cl. CPC B60W 50/085; G05B 13/0265; B60W 50/14

(57) ABSTRACT

A replacement confirmation system includes: a retaining unit that retains a learning model, which is generated by machine learning and outputs a parameter used for vehicle control; an acquirer that acquires a result of confirmation with a driver of a vehicle regarding permission for replacement of a parameter output function other than a learning model used in vehicle control with a learning model; and a determination unit that determines to perform replacement with a learning model when the acquirer has acquired permission from a driver.

### CROSS-REFERENCE TO RELATED APPLICATIONS

This application claims priority to Japanese Patent Application No. 2021-186914 filed on Nov. 17, 2021, which is incorporated herein by reference in its entirety including the description, claims, drawings, and abstract.

### BACKGROUND

### 1. Technical Field

The present disclosure relates to a technology for replacing part of a vehicle system with a learning model generated by machine learning.

### 2. Description of Related Art

JP-A-2020-93760 discloses a control support device that supports control of a vehicle using a learned model generated by machine learning. The control support device includes a control unit that selects a learned model corresponding to the current position of a vehicle based on vehicle information and position information transmitted from the vehicle, and a transmission unit that transmits the selected learned model to the vehicle. Upon reception of a new learned model, the vehicle updates the learned model.
Patent Literature 1: Japanese Unexamined Patent Application Publication No. 2020-93760 (JP-A-2020-93760)

In the technology described in JP-A-2020-93760, a vehicle updates the learned model upon reception of a new learned model. However, the process may not be consistent with the driver's intent.

### SUMMARY

A general purpose of the present disclosure is to provide a technology for replacing a learning model in line with the driver's intent.

In response to the above issue, a replacement confirmation system of one aspect of the present disclosure includes: a retaining unit that retains a learning model, which is generated by machine learning and outputs a parameter used for vehicle control; an acquirer that acquires a result of confirmation with a driver of a vehicle regarding permission for replacement of a parameter output function other than a learning model used in vehicle control with a learning model; and a determination unit that determines to perform replacement with a learning model when the acquirer has acquired permission from a driver.

Another aspect of the present disclosure relates to a replacement confirmation method. The method includes: retaining a learning model, which is generated by machine learning and outputs a numerical value used for vehicle control; acquiring a result of confirmation with a driver of a vehicle regarding permission for replacement of a numerical value output function other than a learning model used in vehicle control with a learning model; and determining to perform replacement with a learning model when permission from a driver has been acquired.

### BRIEF DESCRIPTION OF THE DRAWINGS

An embodiment will now be described, by way of example only, with reference to the accompanying drawings that are meant to be exemplary, not limiting, and wherein like elements are numbered alike in several figures, in which:

FIG. 1 is a diagram used to describe a basic configuration of a replacement confirmation system according to an embodiment;

FIG. 2A is a diagram that shows an image on a display of a vehicle-mounted device displayed to confirm with a driver;

FIG. 2B is a diagram that shows an image on a display of a vehicle-mounted device displayed to confirm with a driver;

FIG. 3 shows a functional configuration of the replacement confirmation system according to the embodiment; and

FIG. 4 is a flowchart of processing for replacement with a learning model.

### DETAILED DESCRIPTION

An embodiment will now be described. The embodiment is illustrative and is not intended to be limiting.

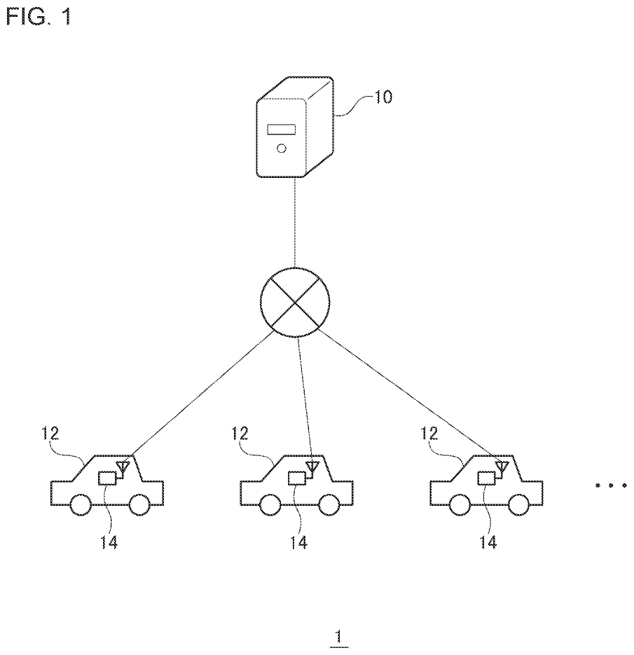

FIG. 1 is a diagram used to describe a basic configuration of a replacement confirmation system 1 according to an embodiment. The replacement confirmation system 1 includes a server device 10, and a vehicle-mounted device 14 mounted on each of multiple vehicles 12. The server device 10 and multiple vehicle-mounted devices 14 are connected by a network via radio stations.

The replacement confirmation system 1 is capable of replacing part of a vehicle control system used in a vehicle-mounted device 14 with a learning model generated by machine learning. The server device 10 retains a learning model and can issue, to multiple vehicles 12 of the same vehicle type, an instruction for replacement with the learning model.

Among the drivers of vehicles 12 of the same vehicle type, some drivers may not trust technologies using artificial intelligence and may not wish the replacement with a learning model. Accordingly, the replacement confirmation system 1 of the embodiment performs processing for confirming, with a driver, replacement of part of a vehicle control system with a learning model. If the driver permits the replacement with the learning model, the vehicle-mounted device 14 will perform the replacement with the learning model. If the driver does not permit the replacement, on the other hand, the vehicle-mounted device 14 will not perform the replacement with the learning model. Therefore, when an artificial intelligence technology is to be used, the driver's intent can be reflected.

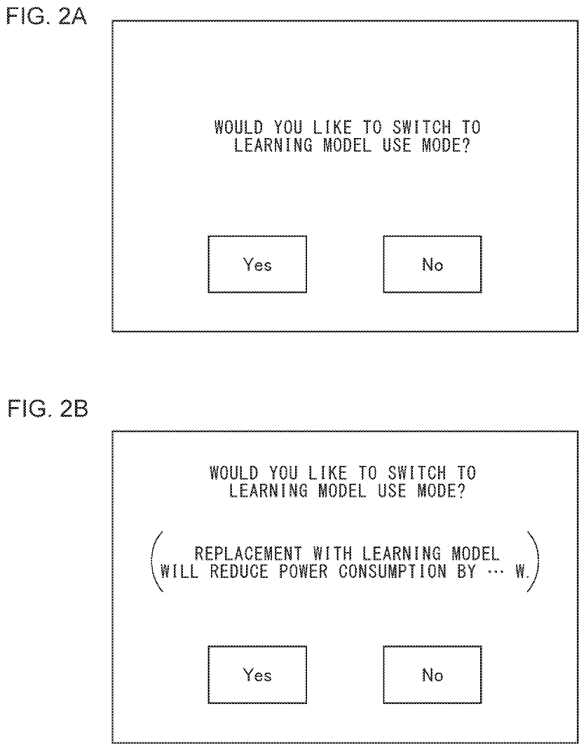

FIG. 2 are diagrams that each show an image on a display of a vehicle-mounted device 14 displayed to confirm with the driver. On the display shown in FIG. 2A, the question of “WOULD YOU LIKE TO SWITCH TO LEARNING MODEL USE MODE?” is output, and button areas of “Yes” and “No” are displayed with which the driver can answer. The display of the vehicle-mounted device 14 also functions as a touch panel, so that the driver can answer by touch operation. If the driver touches “Yes”, the switching is permitted, and, if the driver touches “No”, the switching is not permitted.

On the display shown in FIG. 2B, to the question of “WOULD YOU LIKE TO SWITCH TO LEARNING MODEL USE MODE?”, the information of “REPLACEMENT WITH LEARNING MODEL WILL REDUCE POWER CONSUMPTION BY . . . W.” is added. Thus, an advantage obtained by the replacement with the learning model is displayed to recommend the use of the learning model to the driver. In this way, the driver's intent can be confirmed.

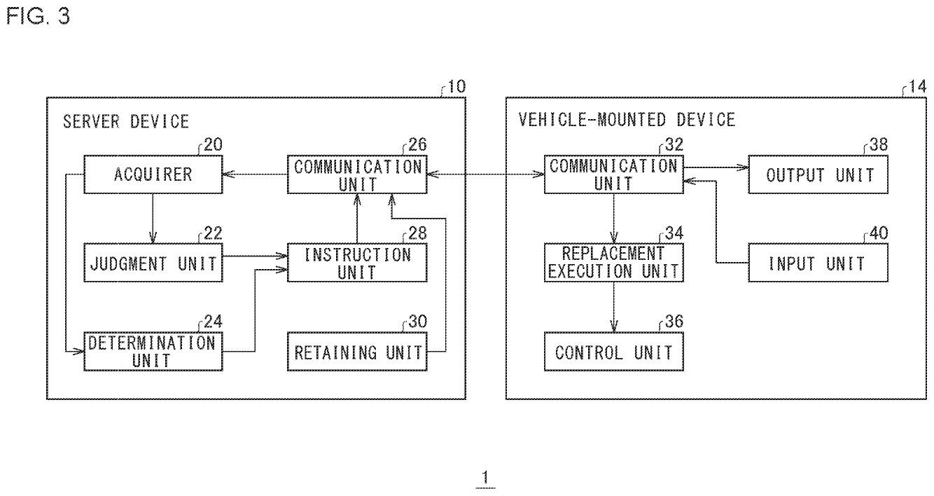

FIG. 3 shows a functional configuration of the replacement confirmation system 1 according to the embodiment. Each function of the replacement confirmation system 1 can be implemented by a circuit block, memory, an LSI or the like in terms of hardware, and by memory-loaded system software, a memory-loaded application program, or the like in terms of software. Therefore, it will be obvious to those skilled in the art that each function of the replacement confirmation system 1 may be implemented in a variety of forms by hardware only, software only, or a combination thereof, and the form is not limited to any of them.

The server device 10 includes an acquirer 20, a judgment unit 22, a determination unit 24, a communication unit 26, an instruction unit 28, and a retaining unit 30. Also, each vehicle-mounted device 14 includes a communication unit 32, a replacement execution unit 34, a control unit 36, an output unit 38, and an input unit 40.

The communication unit 26 of the server device 10 can communicate with multiple vehicle-mounted devices 14. The retaining unit 30 retains a learning model generated by machine learning. The learning model outputs a parameter used for vehicle control.

For example, the learning model outputs a control parameter using a multilayer perceptron type neural network. The learning model includes an input layer to which each operating condition parameter is input, an output layer that outputs a control parameter, and one or more intermediate layers provided between the input layer and the output layer. Each intermediate layer includes multiple nodes, which each perform a fully connected operation on the output value from each node included in the preceding layer. Also, in the output layer, a control parameter (such as a target torque value) may be calculated by performing a sigmoid operation on the output from the preceding layer, for example. A control parameter calculated by the learning model is used in the control unit 36 of a vehicle-mounted device 14.

The learning model receives a detected value from an accelerator sensor and a detected value from a brake sensor and outputs a target torque value used for driving control of a vehicle 12. When the learning model is not used, the target torque value is corrected based on a feedback value, and the control unit 36 controls the engine based on the corrected control parameter. The feedback value is calculated by multiplying the difference between an estimated actual torque output value and the target torque value by a predetermined coefficient. When the absolute value of the feedback value falls within a predetermined tolerance range, it is judged that the engine is outputting targeted torque with the corrected control parameter.

The control unit 36 stores, in the memory, a set of the corrected control parameter and the operating condition parameters used to calculate the control parameter before the correction (target torque value), as one of teacher data used for learning in the learning model. In other words, since the learning model is generated by learning using the operating condition parameters and the feedback values as teacher data, under similar operating conditions, a target torque value with a smaller feedback value can be calculated. The learning model learns according to a predetermined learning method using the teacher data stored in the memory. When the learning model is a multilayer perceptron type neural network, the learning model is made to learn by updating the weight factor or the like of each node in each intermediate layer of the neural network according to the error back propagation method. The learning process is performed by a learning device separate from the server device 10, and the retaining unit 30 receives a learning model generated by machine learning from the learning device and stores the learning model.

The instruction unit 28 instructs a vehicle-mounted device 14 to confirm, with the driver, whether to replace a parameter output function other than a learning model used in vehicle control with a learning model. This can confirm the driver's intent on the vehicle-mounted device 14. The parameter output function other than a learning model used in vehicle control may be, for example, a conventional target torque value output function, which calculates a target torque value using a predetermined formula with the accelerator sensor value and the brake sensor value as input.

After the instruction unit 28 has issued the confirmation instruction, the acquirer 20 acquires, from the vehicle-mounted device 14, the result of confirmation with the driver of the vehicle 12 regarding permission for the replacement of a parameter output function other than a learning model used in vehicle control with a learning model. When the acquirer 20 has acquired the driver's permission, the determination unit 24 determines to perform the replacement with the learning model; when the acquirer 20 has not acquired the driver's permission, the determination unit 24 determines not to perform the replacement with the learning model. In response to the determination for the replacement by the determination unit 24, the instruction unit 28 instructs the vehicle-mounted device 14 to replace the parameter output function other than a learning model with the learning model.

The judgment unit 22 judges whether or not to confirm, with the driver, replacement with a learning model. If the acquirer 20 has acquired disapproval from the driver in the past and if the disapproved learning model is updated, the judgment unit 22 will judge that the replacement with the learning model should be confirmed again with the driver. Thus, even if the driver has disapproved replacement with a learning model in the past, when the learning model is updated, the replacement can be confirmed again with the driver.

The judgment unit 22 may judge that confirmation with the driver should be performed again when the updated learning model has improved accuracy of outputting a parameter, compared to the learning model disapproved by the driver. This can notify the driver of usefulness of the updated learning model and prompt the driver to decide on the replacement. The accuracy of an output parameter of the learning model can be calculated by comparison with a feedback value. For example, the server device 10 acquires actual driving data from a dashboard camera and inputs the driving data into the updated learning model to output a target torque value. Based on the difference between the target torque value and a control value obtained by correcting the target torque value of the actual driving data using a feedback value, the accuracy of the output parameter of the updated learning model can be calculated. When the difference between the target torque value output by the learning model and the actual control value is smaller, the calculated accuracy becomes higher. The accuracy of the output parameter of the learning model may be transmitted to the vehicle-mounted device 14 and conveyed to the driver. The accuracy of the output parameter of the learning model is retained in the retaining unit 30.

When the judgment unit 22 judges that the confirmation with the driver should be performed, the instruction unit 28 instructs the vehicle-mounted device 14 to confirm with the driver. At the time, the instruction unit 28 transmits information regarding the learning model together with the instruction information. The information regarding the learning model includes the contents of the learning model and information explaining advantages of the replacement with the learning model. The retaining unit 30 retains a list of vehicle IDs for which confirmation instructions are issued. The communication unit 26 refers to the vehicle IDs retained in the retaining unit 30 in response to an instruction from the instruction unit 28 and transmits the instruction information to a corresponding vehicle-mounted device 14.

The communication unit 32 of each vehicle-mounted device 14 can communicate with the server device 10. When transmitting information to the server device 10, the communication unit 32 transmits the information with the vehicle ID attached thereto. When the communication unit 32 receives the confirmation instruction from the server device 10, the output unit 38 confirms, with the driver, the replacement with a learning model.

The output unit 38 is a display or speaker and capable of outputting information to the driver. The input unit 40 is a touch panel or microphone and accepts input from the driver. As shown in FIGS. 2A and 2B, the output unit 38 outputs to the driver the confirmation information of “WOULD YOU LIKE TO SWITCH TO LEARNING MODEL USE MODE?”. The driver inputs the answer to the input unit 40 by touch input or voice input. In this way, the replacement with a learning model is confirmed with the driver, so that the driver's intent can be reflected.

When confirming with the driver, the output unit 38 may output, to the driver, information indicating advantages of the replacement with the proposed learning model, or information indicating disadvantages of not performing the replacement with the proposed learning model. FIG. 2B shows a state where the information indicating an advantage of the replacement with the proposed learning model is output to the driver. For example, if a control parameter detected by a vehicle-mounted sensor can be output by the learning model, the power consumption for the use of the vehicle-mounted sensor can be reduced. The information indicating disadvantages of not performing the replacement with the proposed learning model describes the opposite effect of the advantages, such as “IF REPLACEMENT WITH LEARNING MODEL IS NOT PERFORMED, EXTRA POWER CONSUMPTION OF . . . W WILL BE REQUIRED.” This can prompt the driver to decide on the replacement with the learning model.

The communication unit 32 transmits to the server device 10 the result of the driver's input, i.e., information indicating whether or not the replacement with the learning model is permitted. The acquirer 20 of the server device 10 acquires the result of the driver's input and stores it, in the retaining unit 30, together with the vehicle ID and information on a disapproved learning model. Accordingly, if a disapproved learning model is updated, the replacement therewith can be confirmed again with the driver.

The replacement execution unit 34 receives a replacement instruction and a learning model from the instruction unit 28 of the server device 10 and performs processing for replacing part of the system with the learning model. For example, the replacement execution unit 34 performs processing for replacing an existing program for outputting the target torque value with the learning model. The control unit 36 performs vehicle control using the learning model.

The replacement execution unit 34 may be able to switch between a learning model use mode and a learning model non-use mode in response to the driver's input. The learning model non-use mode is a control method originally used without using a learning model. When the driver wishes not to use the learning model after permitting the learning model use mode, the driver may input, to the input unit 40, an instruction to switch to the learning model non-use mode. Based on the input result, the replacement execution unit 34 performs processing for switching back from the learning model use mode to the learning model non-use mode. This allows the driver to easily try out a learning model.

Although the embodiment describes a mode in which the control parameter output by the learning model is the target torque value, the mode is not limited thereto. For example, the control parameter may be a peak value of the pressure in the combustion chamber of the internal combustion engine, which is usually calculated based on the detection results from a pressure sensor that detects the pressure in the combustion chamber of the internal combustion engine. More specifically, knocking caused by vibration of the internal combustion engine is detected by a knocking sensor, and, based on the detected knocking intensity, the learning model may estimate a peak value of the pressure in the combustion chamber. When the detection result from the knocking sensor is input to the learning model, the learning model outputs the peak value of the pressure in the combustion chamber. This can eliminate the need for a pressure sensor for detecting the pressure in the combustion chamber. Also, the control parameter may be the amount of fuel injection of the internal combustion engine. Thus, the control parameter may be a parameter used for driving control of a vehicle. The control parameter is at least not a parameter used for judgment of failure in a vehicle-mounted device.

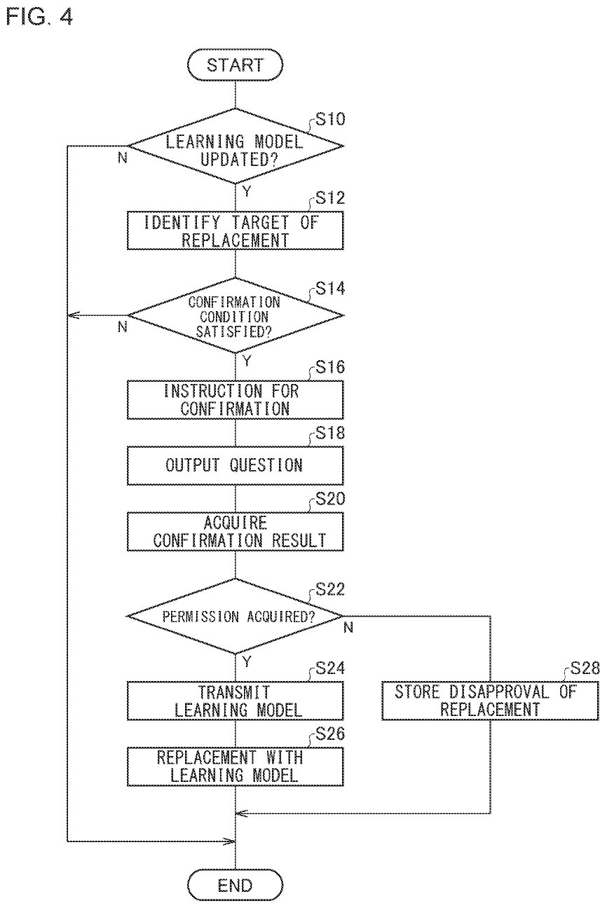

FIG. 4 is a flowchart of processing for replacement with a learning model. The judgment unit 22 judges whether the retaining unit 30 has been updated with a learning model, i.e., whether a learning model has been updated or a new learning model has been stored (S10). When no learning model has been updated or no new learning model has been stored (N at S10), the processing is terminated.

When a learning model has been updated or a new learning model has been stored (Y at S10), the judgment unit 22 identifies a vehicle for which replacement with the learning model is to be performed (S12). A list of vehicles for which replacement with the learning model is to be performed is retained in the retaining unit 30.

The judgment unit 22 judges whether a vehicle for which replacement with the learning model is to be performed satisfies a predetermined confirmation condition (S14). The predetermined confirmation condition is satisfied when the learning model is a kind of learning model distributed for the first time. Also, when a learning model disapproved by the driver in the past has been updated and when the updated learning model has improved accuracy of outputting a parameter compared to the disapproved learning model, the predetermined confirmation condition is satisfied. When the predetermined confirmation condition is not satisfied (N at S14), the processing is terminated.

When the predetermined confirmation condition is satisfied (Y at S14), the judgment unit 22 transmits the judgment result to the instruction unit 28, and the instruction unit 28 transmits, to the corresponding vehicle-mounted device 14, instruction information to confirm with the driver whether the replacement of a parameter output function other than a learning model used in vehicle control with the learning model is permitted (S16).

The output unit 38 of the vehicle-mounted device 14 outputs a question to confirm with the driver whether the replacement with the learning model is permitted (S18). The input unit 40 receives the driver's answer, and the communication unit 32 transmits the result of confirmation with the driver to the server device 10. The acquirer 20 of the server device 10 then acquires the result of confirmation with the driver (S20).

The determination unit 24 judges whether the driver has permitted the replacement (S22). When the driver has permitted the replacement (Y at S22), the determination unit 24 determines to perform the replacement with the learning model, and the instruction unit 28 transmits, to the vehicle-mounted device 14, the learning model together with an instruction for the replacement with the learning model (S24). The replacement execution unit 34 of the vehicle-mounted device 14 then performs processing for replacing part of the vehicle's system with the learning model (S26).

When the driver has disapproved the replacement (N at S22), the determination unit 24 determines not to perform the replacement with the learning model and stores, in the retaining unit 30, information on the disapproved learning model and the vehicle ID related to each other (S28).

The present disclosure has been described with reference to an embodiment. The present disclosure is not limited to the embodiment described above, and various modifications including design modifications may be added based on the knowledge of those skilled in the art.

For example, although the embodiment describes a mode in which the judgment unit 22, which judges whether or not to confirm replacement with a learning model with a driver, and the determination unit 24, which determines to perform the replacement with the learning model when the driver has permitted the replacement, are provided in the server device 10, the mode is not limited thereto. The configurations of the judgment unit 22 and the determination unit 24 may be provided in each vehicle-mounted device 14, for example. In this mode, the server device 10 may transmit a new learning model together with the confirmation instruction to a vehicle-mounted device 14.

Also, although the embodiment describes a mode in which the server device 10 determines the start of processing for replacement with a learning model, the mode is not limited thereto. For example, the administrator of the server device 10 may allow the server device 10 to retain a learning model and a list of vehicles for which replacement with the learning model is to be performed and may provide input to start the replacement processing. In other words, the trigger for starting the replacement processing may be the administrator of the server device 10.

What is claimed is:

1. A replacement confirmation system, comprising:
a retaining unit that retains a learning model, which is generated by machine learning and outputs a parameter used for vehicle control;
an acquirer that acquires a result of confirmation with a driver of a vehicle regarding permission for replacement of a parameter output function other than a learning model used in vehicle control with a learning model; and
a determination unit that determines to perform replacement with a learning model when the acquirer has acquired permission from a driver.

2. The replacement confirmation system according to claim 1, further comprising a judgment unit that judges whether to confirm, with a driver, replacement with a learning model, wherein
when the acquirer has acquired disapproval from a driver in the past and when the disapproved learning model is updated, the judgment unit judges that the replacement with the learning model is to be confirmed again with the driver.

3. The replacement confirmation system according to claim 2, wherein, when an updated learning model has improved accuracy of outputting a parameter compared to the learning model disapproved by a driver, the judgment unit judges that confirmation with the driver is to be performed again.

4. The replacement confirmation system according to claim 1, further comprising an output unit that confirms, with a driver, replacement with a learning model, wherein
when confirming with a driver, the output unit outputs, to the driver, at least one of information indicating an advantage of the replacement with a proposed learning model or information indicating a disadvantage of not performing the replacement with the proposed learning model.

5. A replacement confirmation method, comprising:
retaining a learning model, which is generated by machine learning and outputs a parameter used for vehicle control;
acquiring a result of confirmation with a driver of a vehicle regarding permission for replacement of a parameter output function other than a learning model used in vehicle control with a learning model; and
determining to perform replacement with a learning model when permission from a driver has been acquired.

6. The replacement confirmation system according to claim 2, further comprising an output unit that confirms, with a driver, replacement with a learning model, wherein
when confirming with a driver, the output unit outputs, to the driver, at least one of information indicating an advantage of the replacement with a proposed learning model or information indicating a disadvantage of not performing the replacement with the proposed learning model.

7. The replacement confirmation system according to claim 3, further comprising an output unit that confirms, with a driver, replacement with a learning model, wherein
when confirming with a driver, the output unit outputs, to the driver, at least one of information indicating an advantage of the replacement with a proposed learning model or information indicating a disadvantage of not performing the replacement with the proposed learning model.
